(19) United States
(12) Patent Application Publication
(10) Pub. No.: US 2012/0243034 A1
(43) Pub. Date: Sep. 27, 2012

(54) PRINTING INFORMATION MANAGING DEVICE, PRINTER, PRINTING INFORMATION MANAGING SYSTEM, PRINTING SYSTEM, AND NON-TRANSITORY COMPUTER READABLE MEDIUM RELATED THERETO

(75) Inventor: Takashi HIRAI, Kanagawa (JP)

(73) Assignee: FUJI XEROX CO., LTD., Tokyo (JP)

(21) Appl. No.: 13/225,063

(22) Filed: Sep. 2, 2011

(30) Foreign Application Priority Data
Mar. 25, 2011 (JP) 2011-068750

(51) Int. Cl. G06K 15/00

(52) U.S. Cl. 358/1.15

(57) ABSTRACT

A printing information managing device includes: a storage processing unit that when printing information transmitted from a transmission device is received, stores the received printing information in a memory and deletes printed printing information from the memory; a batch print permission date and time setting unit that sets batch print permission date and time, which is end date and time of a period of batch printing when batch printing of the printing information stored in the memory is designated, for each item of the received printing information; and a controller that when the batch printing is designated, makes a control such that printing information not past the batch print permission date and time of the printing information stored in the memory is printed by a printer and printing information past the batch print permission date and time is not printed by the printer.

### CROSS-REFERENCE TO RELATED APPLICATIONS

This application is based on and claims priority under 35 USC 119 from Japanese Patent Application No. 2011-068750 filed Mar. 25, 2011.

### BACKGROUND

### Technical Field

The present invention relates La a printing information managing device, a printer, a printing information managing system, a printing system, and a non-transitory computer readable medium related thereto.

### SUMMARY

According to an aspect of the invention, there is provided a printing information managing device including: a storage processing unit that when printing information transmitted from a transmission device is received, stores the received printing information in a memory and deletes printed printing information from the memory; a batch print permission date and time setting unit that sets batch print permission date and time, which is end date and time of a period of batch printing when batch printing of the printing information stored in the memory is designated, for each item of the received printing information; and a controller that when the batch printing is designated, makes a control such that printing information not past the batch print permission date and time of the printing information stored in the memory is printed by a printer and printing information past the batch print permission date and time is not printed by the printer.

### BRIEF DESCRIPTION OF THE DRAWINGS

Exemplary embodiments of the present invention will be described in detail based on the following figures, wherein:

FIG. 1 is a view showing the configuration of a printing system according to an exemplary embodiment;

FIG. 2 is a view showing an example of the configuration of a server apparatus and a client apparatus;

FIG. 3 is a view showing an example of the configuration of a printer;

FIG. 4 is a flowchart showing an example of the printing information receiving processing routine;

FIG. 5 is a view showing an example of a management table;

FIG. 6 is a flow chart showing an example of the determination processing routine;

FIG. 7 is a flow chart showing an example of the print control processing routine;

FIG. 8A is a view showing a display example of a printing designation screen, and FIG. 8B is a view showing a display example of a printing information selection image including a list of printing information;

FIG. 9 is a flow chart showing another example of the printing information receiving processing routine;

FIG. 10 is a flow chart showing another example of the determination processing routine;

FIG. 11 is a flow chart showing another example of the printing information receiving processing routine;

FIG. 12 is a flow chart showing another example of the determination processing routine;

FIG. 13 is a flow chart showing another example of the print control processing routine; and

FIG. 14 is a view showing another example of the configuration of a printing system.

### DETAILED DESCRIPTION

Hereinafter, an exemplary embodiment will be described in detail with reference to the accompanying drawings.

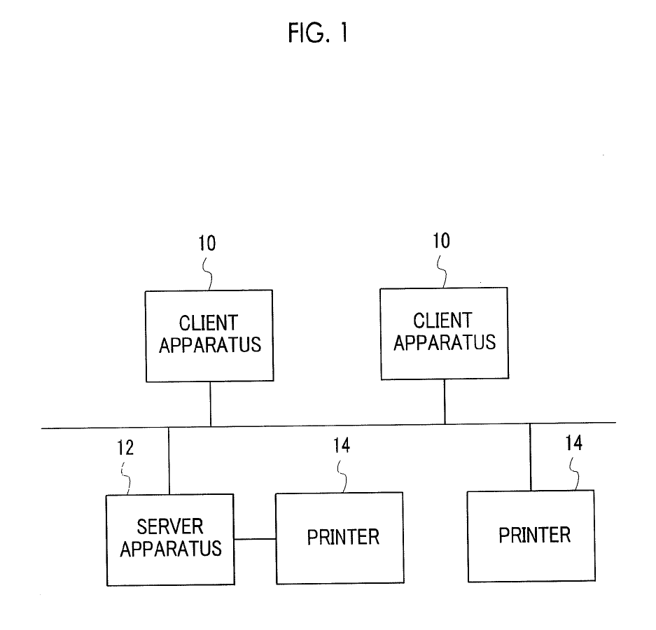

In the present exemplary embodiment, as shown in FIG. 1, plural client apparatuses 10 and a server apparatus 12 are connected to each other through a communication unit 16. In addition, the communication unit 16 may be a public line or may be a network, such as the Internet, a LAN (Local Area Network), or a WAN (Wide Area Network). In addition, the communication unit 16 may be a radio communication unit or may be a communication unit using a cable. A printer 14 is connected to the server apparatus 12 through the communication unit 16 or without the communication unit 16.

Hereinafter, an operation of each apparatus will be schematically described.

The client apparatus 10 generates printing information and transmits it to the server apparatus 12. The printing information includes image information, which specifies an image showing data to be printed, and printing condition information indicating the printing conditions. The printing conditions include enlargement and reduction, size of paper to be printed on, designation of double-sided printing or single-sided printing, direction of a document with respect to paper to be printed on, designation of a color mode or a monochrome mode, and quality of image, for example. The printing information may be described in a page description language.

The server apparatus 12 receives the printing information from the client apparatus 10 and stores and manages it. When there is a request for the printing information from the printer 14, the printing information is read in response to the request and transmitted to the printer 14, from which the request has been transmitted, so that the printer 14 prints it.

In addition, the management of printing information performed by the server apparatus 12 includes not only the processing of storing the received printing information or transmitting the stored printing information in response to the request of the printer 14 but also the processing of deleting the printing information satisfying the conditions set in advance or the processing of returning the printing information. Details of the processing regarding the management of printing information will be described later.

When a user instructs the execution of printing (there are a batch printing instruction and a selective printing instruction, and these will be described later in detail), the printer 14 transmits a request for the printing information to the server apparatus 12 and receives the printing information from the server apparatus 12. The printer 14 generates and prints raster image data on the basis of the printing information received from the server apparatus 12.

In addition, although the case where the printer 14 generates raster image data is described as an example herein, the server apparatus 12 may generate the raster image data and transmit it to the printer 14 instead of transmitting the printing information to the printer 14 by the server apparatus 12.

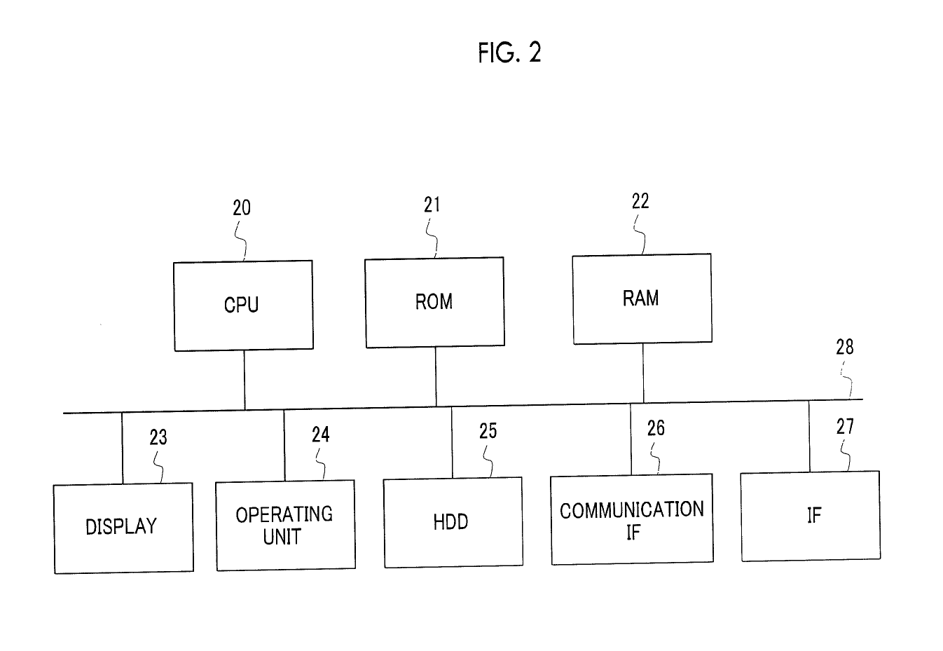

FIG. 2 is a view showing an example of the configuration of the server apparatus 12.

The server apparatus 12 according Lu the present exemplary embodiment has a configuration in which a CPU (Central Processing Unit) 20, a ROM (Read Only Memory) 21, a RAM (Random Access Memory) 22, a display 23, an operating unit 24, an HDD (Hard Disk Drive) 25, a communication IF (Interface) 26, and an IF (Interface) 27 are connected to each other through a bus 28.

The CPU 20 executes a program (including a program of each processing routine, which will be described later, for managing printing information) stored in the ROM 21 or the HDD 25 and controls the entire operation of the server apparatus 12. Programs executed by the CPU 20, data required for processing of the CPU 20, and the like are stored in the ROM 21. The RAM 22 is used as a work memory.

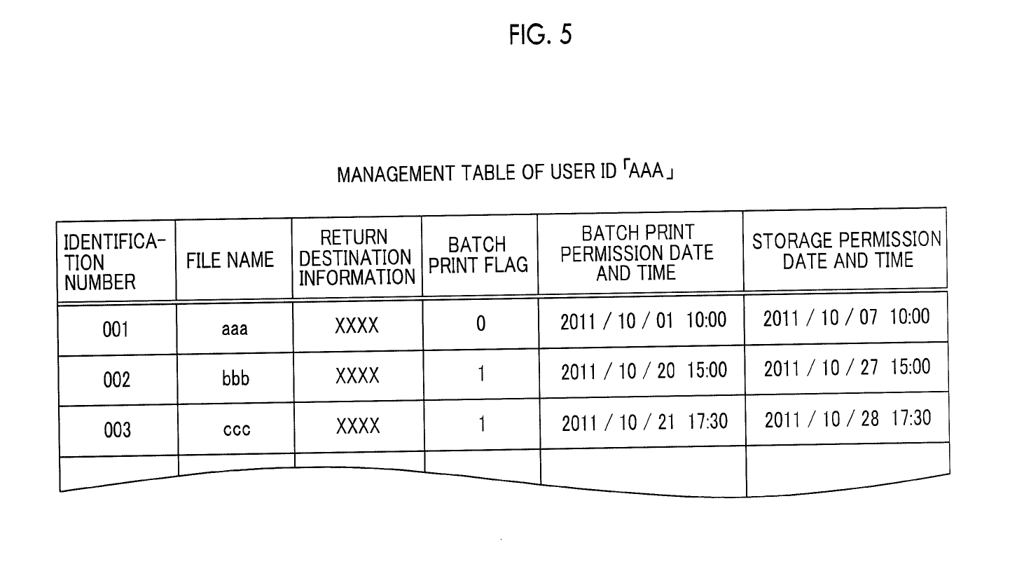

Programs executed by the CPU 20 and various kinds of data are stored in the HDD 25. In addition, a storage region where printing information received from the client apparatus 10 is stored or a storage region where a management table (also refer to FIG. 5) for managing the printing information and the like are stored is also set in the HDD 25 every identification information (user ID) for identifying a user.

In addition, a storage medium for storing a program executed by the CPU 20 or a storage medium on which printing information or a management table is stored is not limited to the HDD 25 or the ROM 21. For example, the storage medium may be a flexible disc, a DVD disc, a magneto-optical disc, or a USB memory (universal serial bus memory) (not shown), or may be a storage device of another apparatus connected to the communication unit 16.

The display 23 is formed by a liquid crystal display, for example, and displays various images, messages, and the like by control of the CPU 20. In addition, the operating unit 24 is formed by a keyboard, a mouse, and the like. The user designates various kinds of information by operating the operating unit 24.

The communication IF 26 is an interface for transmitting and receiving data to and from other apparatuses through the communication unit 16.

The IF 27 is an interface for connection to the printer 14. In addition, an internal clock (not shown) that counts date and time is provided in the server apparatus 12.

In addition, the client apparatus 10 has the same configuration as the server apparatus 12. Here, programs executed by the CPU in the client apparatus 10 include various kinds of application software, a program of a printer driver for generating and transmitting the printing information, and the like.

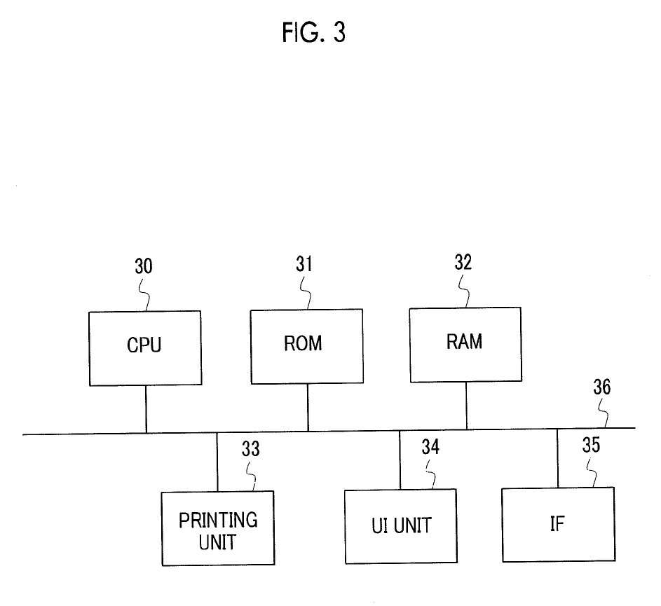

FIG. 3 is a view showing an example of the configuration of the printer 14. Here, an example of the configuration of the printer 14, which is connected to the IF 27 of the server apparatus 12 without the communication unit 16 provided therebetween, will be described.

The printer 14 has a configuration in which a CPU (Central Processing Unit) 30, a ROM (Read Only Memory) 31, a RAM (Random Access Memory) 32, a printing unit 33, a UI (User Interface) unit 34, and an IF (Interface) 35 are connected to each other through a bus 36.

The CPU 30 executes a program stored in the ROM 31 and controls the entire operation of the printer 14. Programs executed by the CPU 30, data required for processing of the CPU 30, and the like are stored in the ROM 31. The RAM 32 is used as a work memory.

In addition, a storage medium for storing a program executed by the CPU 30 is not limited to the ROM 31. For example, the storage medium may be a flexible disc, a END disc, a magneto-optical disc, or a USB memory (not shown).

The UI unit 34 is formed by a touch panel display in which a transmissive touch panel overlaps on a display, for example. Various kinds of information are displayed on the display surface, and desired information or instructions are input when a user touches the touch panel. In addition, an operation button that may be pressed for the input of information may be included in the UI unit 34.

The IF 35 is an interface for connection to the IF 27 of the server apparatus 12.

The printing unit 33 is a printing engine that prints an image. In the printing unit 33, a Y image forming unit that forms a Y (yellow) color image, an M image forming unit that forms an M (magenta) color image, a C image forming unit that forms a C (cyan) color image, and a K image forming unit that forms a K (black) color image are disposed in tandem from the upstream side toward the downstream side along the process direction. In addition, the printing unit 33 is configured to include an intermediate transfer belt, a primary transfer unit, a secondary transfer unit, and a fixing unit. Each of the Y image forming unit, the M image forming unit, the C image forming unit, and the K image forming unit includes: a photoconductor; an electric charger which electrically charges the surface of the photoconductor; an exposure device which exposes the charged photoconductor on the basis of corresponding image data in order to form an electrostatic latent image; and a developing device which develops the electrostatic latent image by making Loner with a color corresponding to each image forming unit adhere to the surface of the photoconductor on which the electrostatic latent image is formed. In addition, each toner image developed by the developing device of each image forming unit is transferred from each photoconductor to the intermediate transfer belt by the primary transfer unit provided in each image forming unit. As a result, the respective toner images overlap each other. In addition, the toner image on the intermediate transfer belt is electrically attracted by the secondary transfer unit so as to he transferred onto recording paper. Then, the toner image transferred onto the recording paper is fixed to the recording paper by the fixing device.

In addition, although the printing unit using an intermediate transfer belt is described as an example herein, it is also possible to transfer a toner image onto recording paper directly without an intermediate transfer belt. In addition, although the tandem type electrophotographic printing unit is described as an example herein, the printing unit is not limited to this. For example, a printing unit in which a rotary developing device is provided may also be used. That is, this printing unit includes one photoconductor, one electric charger, one exposure device, and a developing device that supplies toner corresponding to each color of YMCK. Specifically, a toner image of each color is sequentially formed by forming an electrostatic latent image on the photoconductor charged by the electric charger on the basis of image data for each color of YMCK and then developing it with toner, the toner images are sequentially transferred onto the intermediate transfer belt, and then the toner images are transferred onto recording paper in a state where the toner images overlap each other and are fixed. Moreover, instead of the electrophotographic printing unit, it is possible to use an ink jet printing unit that discharges an ink droplet of each color of YMCK from a recording head corresponding to the image data of each color of YMCK and performs printing while transporting recording paper. Alternatively, it is possible to use a printing unit that prints a monochrome image instead of a color image.

In addition, although not shown in the drawing, it is assumed that a communication IF for connection to the communication unit 16 is provided in addition to the configuration described above in the case of the printer 14 connectable to the communication unit 16.

In the present exemplary embodiment, it is assumed that the printing information is managed by each user. That is, it is assumed that the client apparatus 10 transmits the printing information to the server apparatus 12 together with a user ID and the server apparatus 12 manages the printing information for each user ID. In addition, in the present exemplary embodiment, it is assumed that the UT unit 34 of the printer 14 is also used as a designation unit that designates a user ID and a user inputs a user ID through the UI unit 34. The printer 14 transmits a request for printing information to the server apparatus 12 together with the input user ID (or transmits a request for printing information after transmitting the user ID) and receives the printing information of the user ID from the server apparatus 12.

In addition, although the case where the UI unit 34 of the printer 14 is used as a designation unit for inputting and designating a user ID is described as an example herein, the designation unit is not limited to this. For example, a reader which reads a user ID stored in a memory from an ID card, which includes a memory in which a user ID is stored, may be provided in the printer 14.

In addition, the use of a user ID is an example, and the management of printing information is not limited to those described above.

Next, the operation of the printing system according to the present exemplary embodiment will be described.

First, in the client apparatus 10, the user inputs his or her user ID to log in. In addition, the user designates data to be printed and also designates printing condition information from a setup screen provided by software (here, a printer driver), which is set in advance, in the client apparatus 10. Then, the printer driver generates the printing information for printing the data to be printed.

In addition, as described above, the server apparatus 12 may return the printing information, which is received from the client apparatus 10 and is then stored, to the transmitting person (user) of the printing information. Therefore, when generating the printing information, the user inputs and designates return destination information, which indicates return destination when returning the printing information from the server apparatus 12 to the transmitting person, on the setup screen.

In addition, the return destination information corresponds to the return method. It is assumed that the return method is set in advance. For example, when the return method is to return the printing information using an e-mail, the user's e-mail address may be set as the return destination information. In addition, when the fixed IP address is given to each apparatus in the network, the IP address may be set as the return destination information. In this case, a printer driver may acquire the IP address set in the client apparatus 10 and transmit it together with the printing information without inputting the IP address by the user. In addition, when the server apparatus 12 or the client apparatus 10 is set such that files may be shared on the network, it is possible to adopt a method of converting the printing information through a shared folder. In this case, information specifying a shared file may be set as the return destination information.

In addition, the printer driver transmits the generated printing information to the server apparatus 12 through the communication unit 16 together with the user ID and the return destination information.

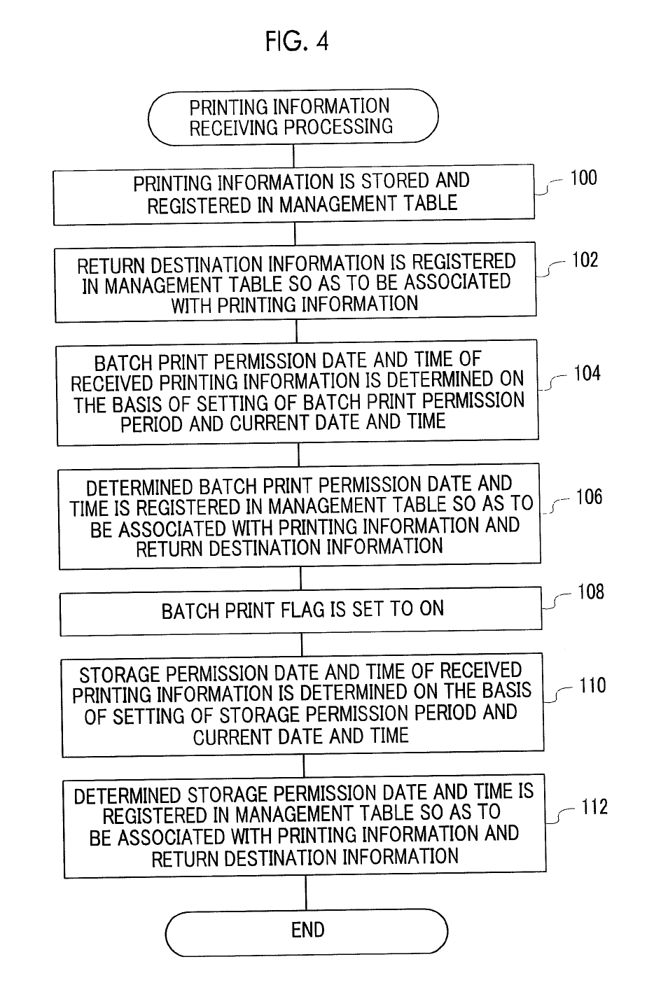

When the printing information is received from the client apparatus 10, the server apparatus 12 executes the printing information receiving processing routine shown in FIG. 4.

In step 100, the received printing information is stored in a storage region set for the user ID received together with the printing information. In addition, an identification number and a file name of the printing information are written in a management table, thereby registering the printing information. The identification information is assumed to be the number which the server apparatus 12 gives to the printing information when the printing information is received, and the file name is assumed to be a name when the printing information is generated at the client apparatus 10 side. The identification information and the file name are used as information by which the printing information may be identified. However, the information by which the printing information may be identified is not limited to them.

FIG. 5 shows an example of the management table. The management table is set for each user ID. The management table is configured such that an identification number, a file name, return destination information, a batch print flag, batch print permission date and time, and storage permission date and time may be registered for one printing information item.

In step 102, the return destination information received together with the printing information is registered in the management table so as to be associated with the printing information. Here, the identification number for identifying the received printing information and the received return destination information are registered in the management table so as to be associated with each other (also refer to the “return destination information” in FIG. 5).

In step 104, batch print permission date and time, which is the end date and time of a batch print permission period of the received printing information, is determined on the basis of the setting of the batch print permission period (length) and the current date and time (date and time when step 104 starts).

In addition, the batch print refers to a printing method in which when a user designates batch print, printing information (here, printing information in which a batch print flag of a management table is ON) of the user stored in the server apparatus 12 is printed collectively, that is, printed together. The batch print flag is a flag indicating whether or not perform batch printing. As will be described later, the initial value of the batch print flag is set to ON, that is, “1” (batch printing is performed), but is set to OFF, that is, “0” (batch printing is not allowed) in the other processing routine described later when the determined batch print permission date and time elapses. By setting the batch print flag to OFF, the printing information associated with the batch print flag set to OFF is excluded from objects of batch print.

In addition, the batch print permission period refers to a period of hatch print when the batch printing is designated. Although the start date and time or the end date and time of the batch print permission period may not be set in advance since they differ depending on the printing information, the length is assumed to be set in the server apparatus 12 in advance. For example, the length is “1 day”, “2 days”, or “3 days and 6 hours”. Moreover, in practice, the start date and time of the batch print permission period is date and time when the server apparatus 12 receives the printing information. However, for the sake of convenience, the date and time when the processing of step 104 starts (current date and time) may be set as the start date and time, and date and time obtained by adding the length of the batch print permission period to the current date and time may be calculated as the batch print permission date and time. In addition, a user himself or herself may set the length of the batch print permission period in the client apparatus 10 for each item of the printing information and may transmit the setup information to the server apparatus 12 together with the printing information. In this case, the server apparatus 12 sets the hatch print permission period, in the same manner as described above, on the basis of the setup information of the batch print permission period received together with the printing information. In addition, it is also possible to set the length of the batch print permission period for each user instead of setting it for each item of the printing information.

Here, although the date and time when the batch print permission period (length) has elapsed from the current date and time is determined as the batch print permission date and time herein, the batch print permission date and time may also be determined using the “date and time when the printing information is received” instead of the “current date and time”. In addition, the date and time when the printing information is transmitted from the client apparatus 10 may be used instead of the date and time when the printing information is received. The information on this transmission date and time may be transmitted to the server apparatus 12 together with the printing information transmitted from the client apparatus 10.

In step 106, the batch print permission date and time determined as described above is registered in the management table so as to be associated with the printing information and the return destination information (also refer to the “batch print permission date and time” in FIG. 5)

In step 108, the batch print flag of the printing information is set to UN in the management table (also refer to the “batch print flag” in FIG. 5).

In step 110, storage permission date and time, which is the end date and time of a storage permission period of the received printing information, is determined on the basis of the setting of the storage permission period (length) and the current date and time (date and time when step 110 starts).

Here, the storage permission period is a period longer than the batch print permission period, and refers to a period for which the storage of the printing information in a memory (in the present exemplary embodiment, the HDD 25) of the server apparatus 12 is allowed. Although the start date and time or the end date and time of the storage permission period may not be set in advance since they differ depending on the print information, the length is assumed to be set in the server apparatus 12 in advance. For example, the length is “5 days”, “1 week”, or “8 days and 6 hours”. Moreover, in practice, the start date and time of the storage permission period is date and time when the server apparatus 12 receives the printing information. However, for the sake of convenience, the date and time when the processing of step 110 starts (current date and time) may be set as the start date and time, and date and time obtained by adding the length of the storage permission period to the current date and time may be calculated as the storage permission date and time. In addition, a user himself or herself may set the length of the storage permission period in the client apparatus 10 for each item of the printing information and may transmit the setup information to the server apparatus 12 together with the printing information. In this case, the server apparatus 12 sets the storage permission period, in the same manner as described above, on the basis of the setup information of the storage permission period received together with the printing information. In addition, it is also possible to set the length of the storage permission period for each user instead of setting it for each item of the printing information.

Here, although the date and time when the batch print permission period (length) has elapsed from the current date and time is determined as the storage permission date and time herein, the storage permission date and time may also be determined using the “date and time when the printing information is received” instead of the “current date and time”. In addition, the date and time when the printing information is transmitted from the client apparatus 10 may be used instead of the date and time when the printing information is received. The information on this transmission date and time may be transmitted to the server apparatus 12 together with the printing information transmitted from the client apparatus 10.

In step 112, the storage permission date and time determined as described above is registered in the management table so as to be associated with the printing information and the return destination information (also refer to the “storage permission date and time” in FIG. 5).

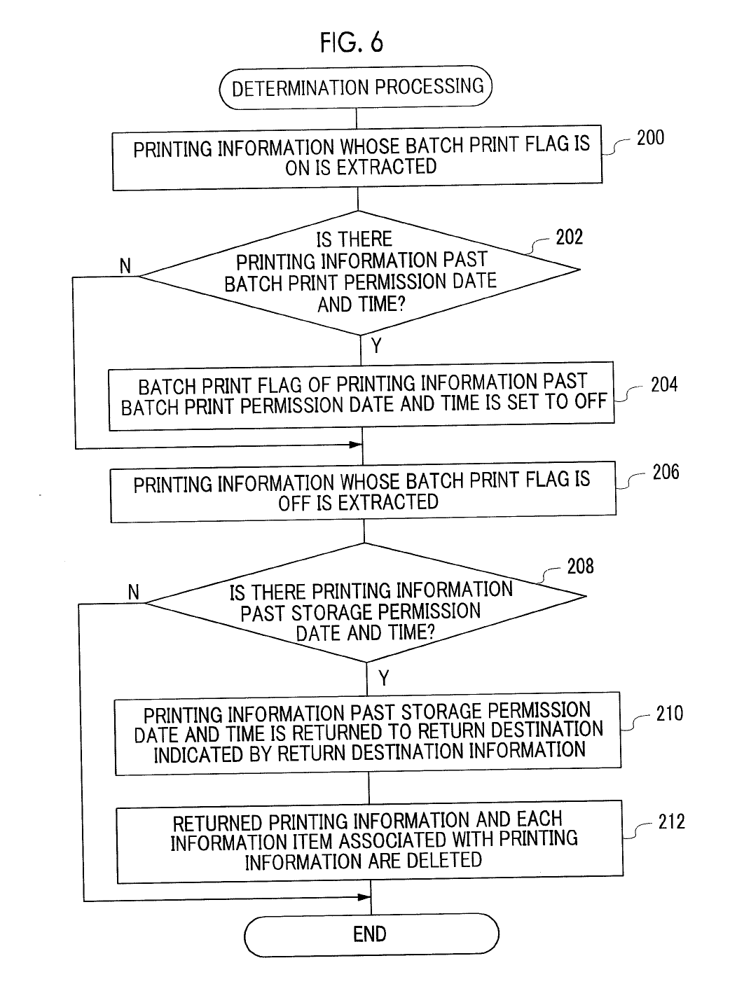

The server apparatus 12 executes a determination processing routine shown in FIG. 6 at a timing set in advance. For example, this determination processing routine may be executed every interval set in advance. In additions, the timing set in advance may include a time when a user prints the printing information stored in the server apparatus 12 (when a selection result of batch printing or selective printing, which will be described later, is received).

In step 200, printing information whose batch print flag is ON is extracted with reference to the management table.

In step 202, information regarding the batch print permission date and time registered so as to be associated with the extracted printing information is read, and the batch print permission date and time is compared with the current date and time (date and time when step 202 starts) to determine whether or not it is printing information past the batch print permission date and time. When it is determined that the extracted printing information is printing information past the batch print permission date and time in step 202, the process proceeds to step 204. In step 204, the batch print flag of the printing information past the batch print permission date and time is changed from the ON state to the OFF state in the management table. Then, the process proceeds to step 206.

In addition, when it is determined that the extracted printing information is not printing information past the batch print permission date and time in step 202, step 204 is skipped and the process proceeds to step 206.

In step 206, printing information whose batch print flag is OFF is extracted with reference to the management table.

In step 208, information regarding the storage permission date and time registered so as to be associated with the extracted printing information is read, and the storage permission date and time is compared with the current date and time (date and time when step 208 starts) to determine whether or not it is printing information past the storage permission date and time. When it is determined that the extracted printing information is printing information past the storage permission date and time in step 208, the process proceeds to step 210. In step 210, the printing information past the storage permission date and time is returned to the return destination indicated by the return destination information, which is registered in the management table so as to be associated with the printing information, using a return method set in advance. For example, when the return method is a method. using an e-mail, the return destination information is an e-mail address. In this case, an email addressed to the e-mail. address is created and transmitted together with the printing information attached thereto as an attached file. In addition, for example, when the return method is a method using a shared folder, the return destination information is information specifying a shared folder. In this case, the printing information is returned by storing the printing information in the specified shared folder.

In step 212, the returned printing information is deleted from the server apparatus 12, and identification information of the printing information and various kinds of information (file name, return destination information, a batch print flag, batch print permission date and time, and storage permission date and time) registered in the management fable so as to be associated with the printing information are deleted from the management table.

In addition, when it is determined that the extracted printing information is not printing information past the storage permission date and time in step 208, steps 210 and 212 are skipped and this determination processing routine ends.

Since the printing information past the storage permission date and time is deleted, lack of the capacity of the memory (here, an HDD) of the server apparatus 12 is suppressed. In addition, when it is necessary to print the printing information after the printing information is deleted, the printing information may be printed using the returned printing information.

Next, printing processing when a user prints the printing information transmitted to the server apparatus 12 using the printer 14 will be described.

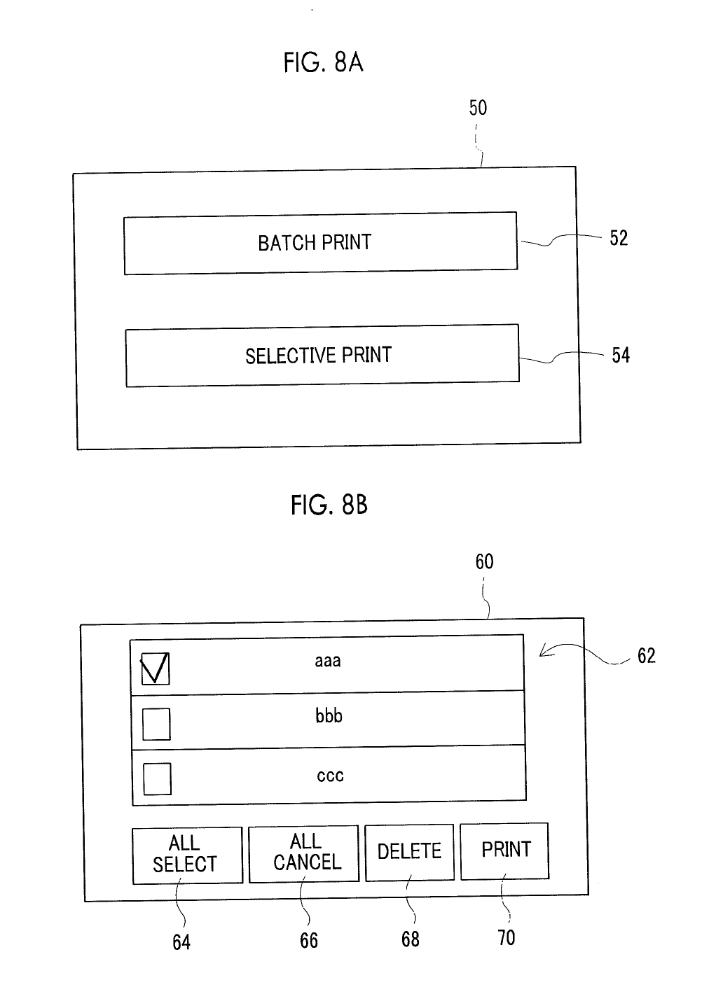

A user inputs a his or her own user ID through the UI unit 34 of the printer 14 which prints the printing information. When the user ID is input, the printer 14 displays a printing designation screen 50 on the UI unit 34, as shown in FIG. 8A. A batch print button 52 for designating batch printing and a selective print button 54 for designating selective printing are displayed on the printing designation screen 50. Here, the selective printing refers to a printing method of printing only the printing information that a user selects from the printing information stored in the server apparatus 12 and not printing the printing information which is not selected by the user. The user may exclusively select and designate either the batch print button 52 or the selective print button 54 by touching it. The user's selection result is transmitted to the server apparatus 12 together with the user ID as a request for the printing information.

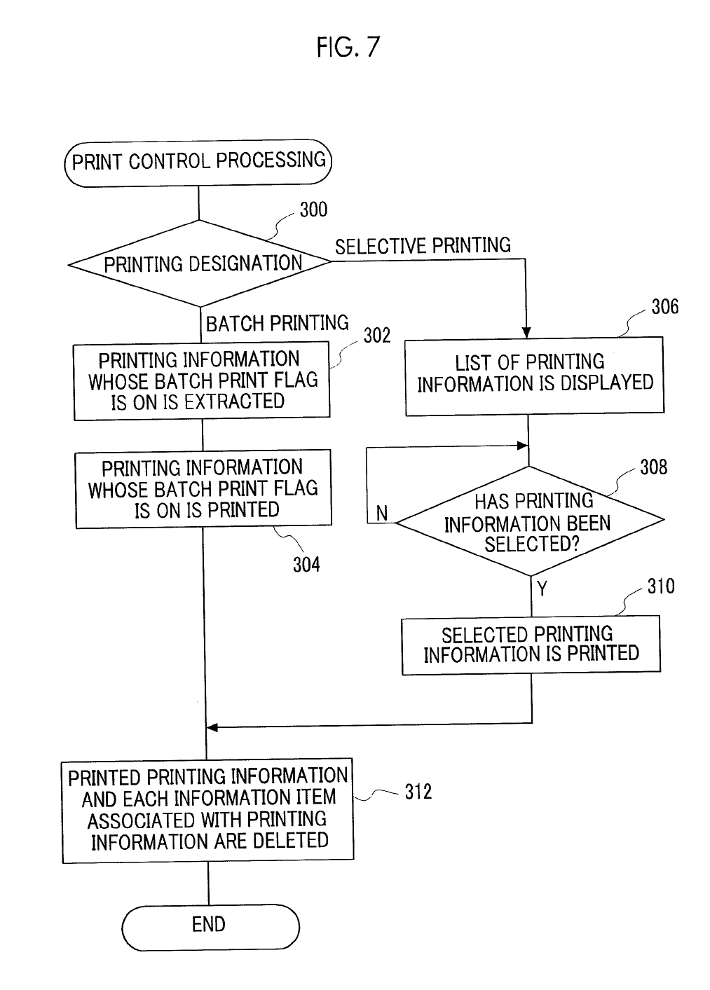

When the selection result is received from the printer 14 together with the user ID, the print control processing routine shown in FIG. 7 is executed in the server apparatus 12.

In step 300, it is determined whether the batch printing has been designated or the selective printing has been designated by the user with reference to the selection result. When it is determined that the hatch printing has been designated by the user in step 300, the process proceeds to step 302.

In step 302, printing information whose batch print flag is ON is extracted with reference to a management table stored corresponding to the user ID received together with the selection result.

In step 304, each item of the extracted printing information (printing information whose batch print flag is ON) is read from a storage region where the printing information of the received user ID is stored and is then transmitted to the printer 14 in order of registration in the management table so that the printing information is collectively printed by the printer 14.

On the other hand, when it is determined that the selective printing has been designated by the user in step 300, the process proceeds to step 306.

In step 306, the list information is transmitted to the printer 14 so that a list of all printing information items registered in the management table of the received user ID is displayed on the UI unit 34 of the printer 14. As the list information, for example, a file name of the printing information may be transmitted or a file name may be transmit Led together with an identification number for identifying each item of the printing information. In addition, the printing information may be transmitted including the receiving date and time.

When the list information is received, the printer 14 displays a printing information selection screen 60, as shown in FIG. 8B. A list section 62, an all select button 64, an all cancel button 66, a delete button 68, and a print button 70 are displayed on the printing information selection screen 60. A list of file names of the printing information is displayed on the list section 62. In addition, although a list of file names is displayed herein, an identification number may be displayed or both an identification number and a file name may be displayed side by side. In addition, the receiving date and time of the printing information may be displayed together.

The user may select the printing information to be printed by selecting a displayed file name. In addition, plural items of the printing information may be selected. When the printing information is selected, a check mark (V mark) is displayed on a check box displayed corresponding to the file name of the printing information.

In addition, when the user touches the all select button 64, a check mark is displayed on each check box corresponding to each file name, such that all file names displayed on the list section 62 are selected.

In addition, when the user touches the all cancel button 66, all selections of the printing information are canceled. As a result, display of a check mark also disappears to return to a state where no printing information is selected. In addition, when the deletion button 68 is touched, a delete command for deleting the selected printing information from the server apparatus 12 is transmitted to the server apparatus 12. When the delete command is received, the server apparatus 12 deletes the printing information and various kinds of information, which is stored so as to be associated with the printing information, from the management table. This is not shown in FIG. 7. In addition, when the print button 70 is touched, the selection result of the printing information is transmitted to the server apparatus 12.

In addition, although an example is described in which the all select button 64 is provided as a button for collectively selecting the printing information to be printed and all items of the printing information (that is, all items of the printing information registered in the management table) displayed on the list section 62 are selected when the user selects the all select button 64 by touching, the invention is not limited to this. For example, although the all select button 64 is a button for collectively selecting the printing information to be printed, the all select button 64 may be a button for collectively selecting only the printing information whose batch print flag is ON among the printing information items registered in the management table. In this case, information regarding a batch print flag of each printing information item is included in the list information transmitted from the server apparatus 12 to the printer 14. When the user touches The all select button 64, the printer 14 makes only the printing information whose batch print flag is ON selected and the printing information whose hatch print flag is OFF not selected with reference to the list information transmitted from the server apparatus 12. In addition, when the print button 70 is touched in this state, this selection result is transmitted to the server apparatus 12.

In step 308, the server apparatus 12 continues waiting until the printing information is selected. When it is determined that the printing information has been selected (that is, the selection result of the printing information has been received from the printer 14) in step 308, it is determined whether or not the selected printing information has been requested, the process proceeds to step 310.

In step 310, the printing information selected by the user is read from a storage region where the printing information of the user ID is stored and is then transmitted to the printer 14 so as to be printed by the printer 14.

After printing by the printer 14 ends in step 304 or 310, the process proceeds to step 312. In step 312, the printing information which has been printed is deleted, and various kinds of information stored in the management table so as to be associated with the printing information is deleted.

Usually, a user checks and selects the printing information transmitted from the client apparatus 10 one by one through the UI unit 34 of the printer 14 and collectively prints the printing information transmitted from the client apparatus 10 by selecting a batch print button rather than printing the printing information individually (selective printing) in many cases. However, it is useless to print the printing information which has not been printed due to the reason that the user forgets printing, for example, and which does not need to be printed by the elapse of time. In the present exemplary embodiment, when batch printing is designated as described above, only the printing information whose batch print flag is ON is printed. Accordingly, useless printing is not performed. However, even if the batch print flag of the printing information is set to OFF so that batch printing of the printing information is not performed, the printing information is not deleted until the storage permission date and time elapses. In this case, if it is necessary to print the printing information after the elapse of the batch print permission date and time, it is possible to designate selective printing to print the printing information.

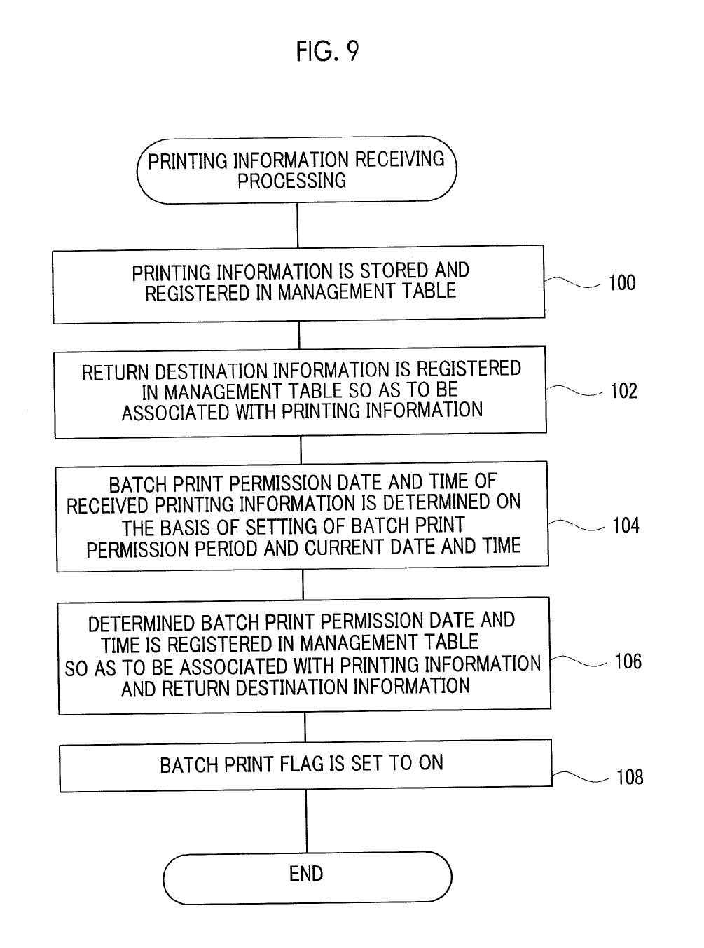

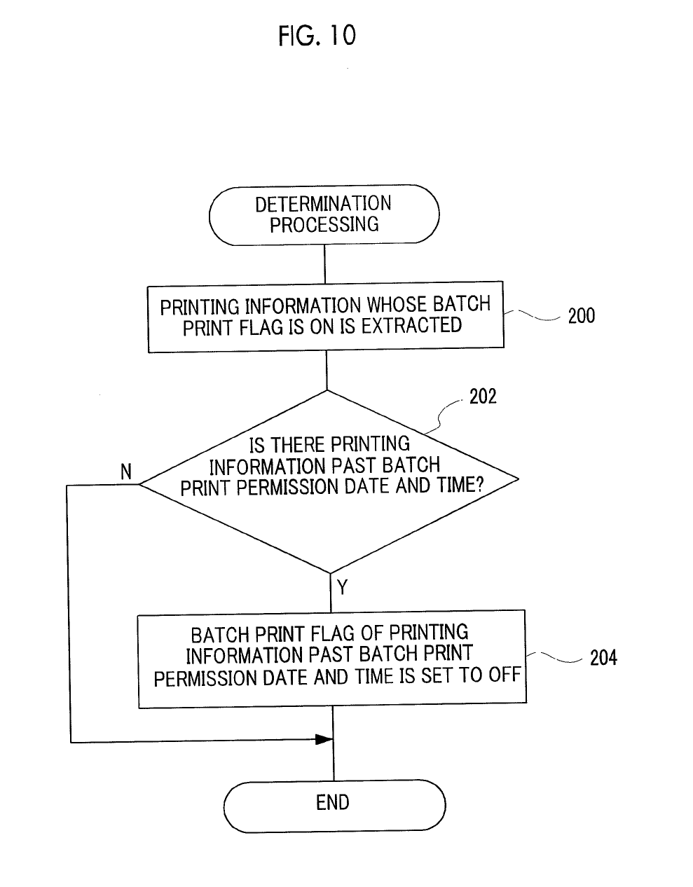

In addition, although an example in which the printing information is managed by determining both the batch print permission date and time and the storage permission date and time is described in the exemplary embodiment, the invention is not limited to this. Fox example, the printing information may be managed so that the elapse of the batch print permission date and time is determined and the elapse of the storage permission date and time is not determined. The printing information receiving processing routine in this case is shown in FIG. 9, and the determination processing routine is shown in FIG. 10. In addition, a table obtained by deleting items of the storage permission date and time and the return destination information from the management table shown in FIG. 5 is used as the management table.

In FIG. 9, steps of executing the same processing as in FIG. 4 are denoted by the same reference numerals as in FIG. 4. In addition, also in FIG. 10, steps of executing the same processing as in FIG. 6 are denoted by the same reference numerals as in FIG. 6.

In FIG. 9, the same processing as in FIG. 4 is performed except that the determination of storage permission date and time (step 110) and the registration of storage permission date and time in the management table (step 112) are not performed.

In FIG. 10, the same processing as in FIG. 6 is performed except that the extraction of printing information whose batch print flag is OFF (step 206), the determination regarding whether or not the storage permission date and time has elapsed (step 208), and the processing after it is determined that the storage permission date and time has elapsed (steps 210 and 212) are not performed.

In addition, even in the case where only the batch print permission date and time is determined, explanation regarding the print control processing routine will be omitted since it may be performed in the same manner as in FIG. 7.

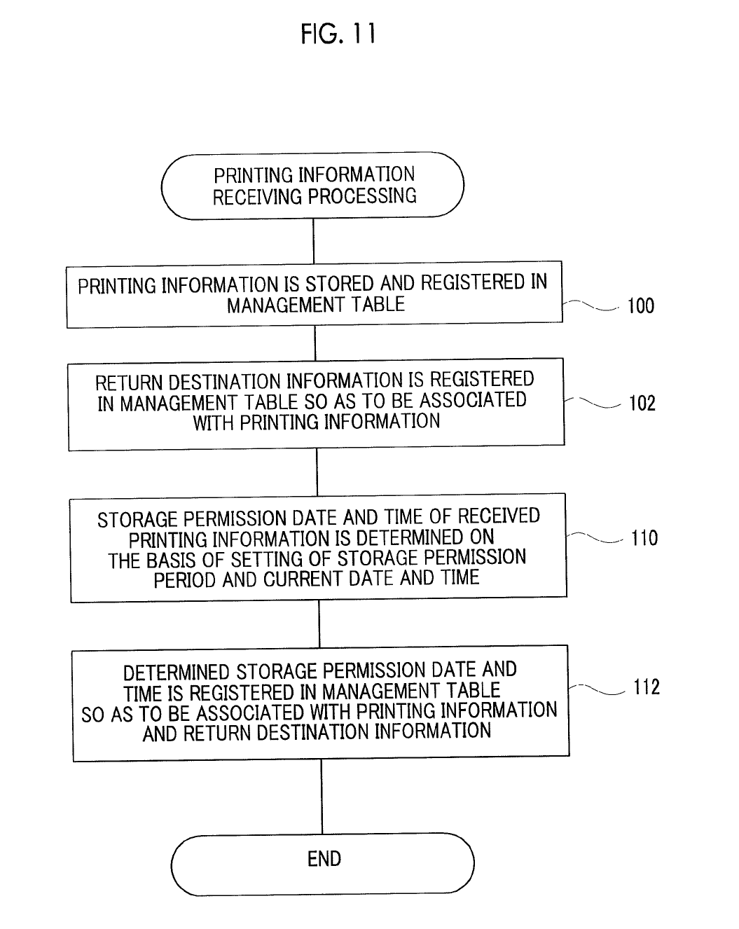

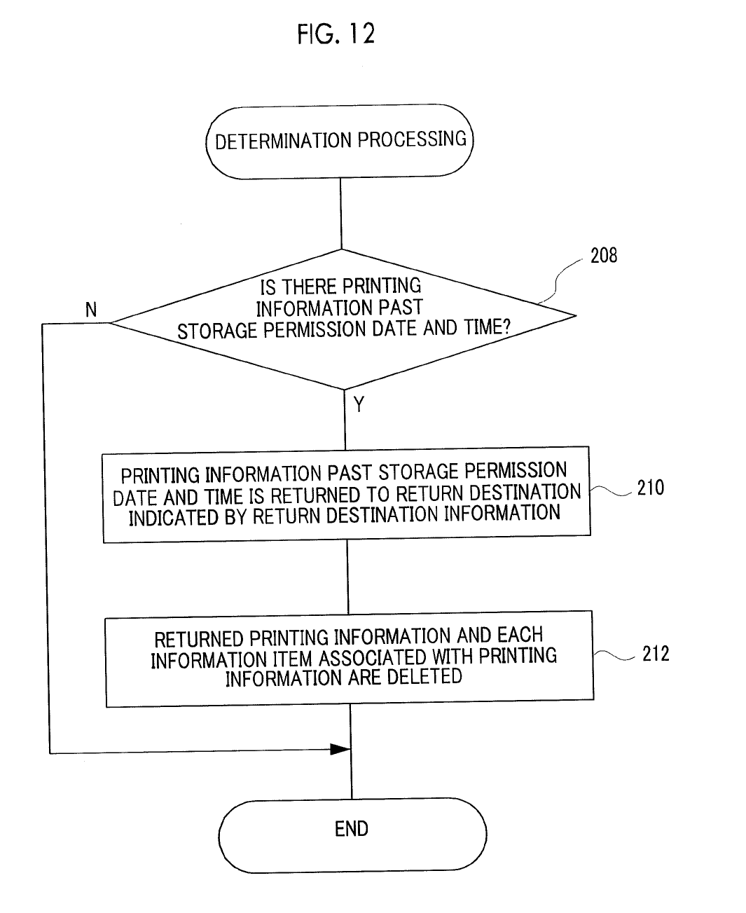

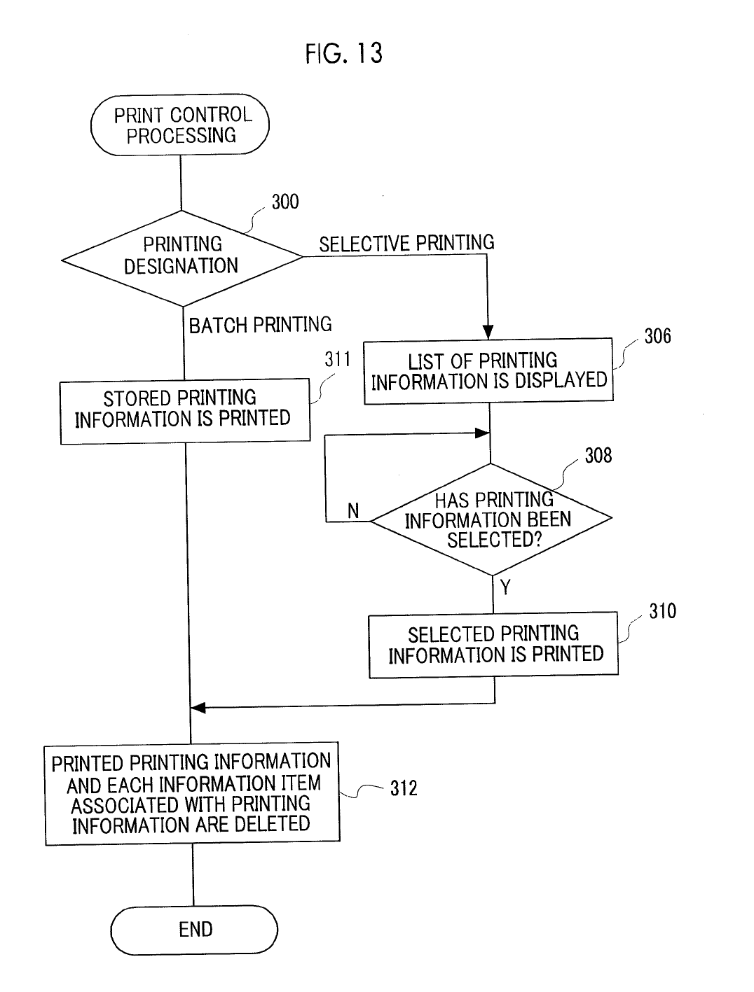

In addition, for example, the printing information may be managed by determining the elapse of the storage permission date and time but not determining the elapse of the batch print permission date and time. The printing information receiving processing routine in this case is shown in FIG. 11, the determination processing routine is shown in FIG. 12, and the print control processing routine is shown in FIG. 13. In addition, a table obtained by deleting items of the batch print permission date and time and the batch print flag from the management table shown in FIG. 5 is used as the management table.

In FIG. 11, steps of executing the same processing as in FIG. 4 are denoted by the same reference numerals as in FIG. 4. In addition, also in FIG. 12, steps of executing the same processing as in FIG. 6 are denoted by the same reference numerals as in FIG. 6. In addition, also in FIG. 13, steps of executing the same processing as in FIG. 7 are denoted by the same reference numerals as in FIG. 7.

In FIG. 11, the same processing as in FIG. 4 is performed except that the determination of batch print permission date and time (step 104), the registration of batch print permission date and time in the management table (step 106), and the setting of the batch print flag (step 108) are not performed.

In FIG. 12, the same processing as in FIG. 6 is performed except that the extraction of printing information whose batch print flag is ON (step 200), the determination regarding whether or not the batch print permission date and time has elapsed (step 202), batch print flag change processing after it is determined that the hatch print permission date and time has elapsed (step 204), and the extraction of printing information whose batch print flag is OFF (step 206) are not performed.

Referring to FIG. 13, in step 300, it is determined whether selective printing has been designated or batch printing has been designated by the user with reference to a selection result after the selection result is received together with a user ID from the printer 14. When it is determined that selective printing has been designated by the user, processing in steps 306 to 312 is performed in the same manner as in FIG. 7. On the other hand, when it is determined that hatch printing has been designated in step 300, the process proceeds to step 311. In step 311, all items of stored printing information are read from a storage region where the printing information of the received user ID is stored so that all items of the printing information stored so as to match the user ID are collectively printed, and the printing information is transmitted to the printer 14 in order of registration in the management table so that the printing information is collectively printed by the printer 14. Then, after the hatch printing, the printing information which has been printed is deleted and each item of the information related to the printing information is also deleted from the management table in step 312, in the same manner as in FIG. 7.

In addition, although a return method when returning the printing information past the storage permission date and time is set in the server apparatus 12 in advance in the above exemplary embodiment, the invention is not limited to this. For example, it is also possible to designate a return method of printing information from the setup screen provided by a printer driver when a user generates and transmits the printing information. In this case, the printer driver transmits the designation result of the return method and the return destination information corresponding to the return method to the server apparatus 12 together with the printing information and the user ID. The server apparatus 12 returns the printing information to the return destination indicated by the return destination information using the designated return method. In this way, user convenience is improved.

In addition, a user ID and return destination information may be stored in advance in a memory of the server apparatus 12 so as to match each other. In this case, the printing information and The user ID may be transmitted from the client apparatus 10 to the server apparatus 12, and transmission of the return destination information may be omitted. When returning the printing information, it is preferable that the server apparatus 12 reads the return destination information, which is stored so as to match the user ID received together with the printing information, from its own memory and returns the printing information.

In addition, although the UI unit 34 is described as a touch panel display in the above exemplary embodiment, the UI unit 34 is not limited to a touch panel. For example, an UI unit that has a display and an operating unit separated from each other may also be used. In addition, although an example in which various kinds of information is designated by touching the touch panel display is described above, the invention may also be designated by operating an operation button if the operation button is provided separately.

In addition, in the exemplary embodiment described above, the printing information past the batch print permission date and time is removed from objects to be collectively printed. However, when transmitting the printing information to the server apparatus 12, the user of the client apparatus 10 may set the printing information so as to be removed from objects to be collectively printed and may transmit the information together with the printing information. In this case, the server apparatus 12 sets the batch print flag of the printing information to OFF according to the information and registers it in the management table. In this case, setting of the hatch print permission date and time is not necessary.

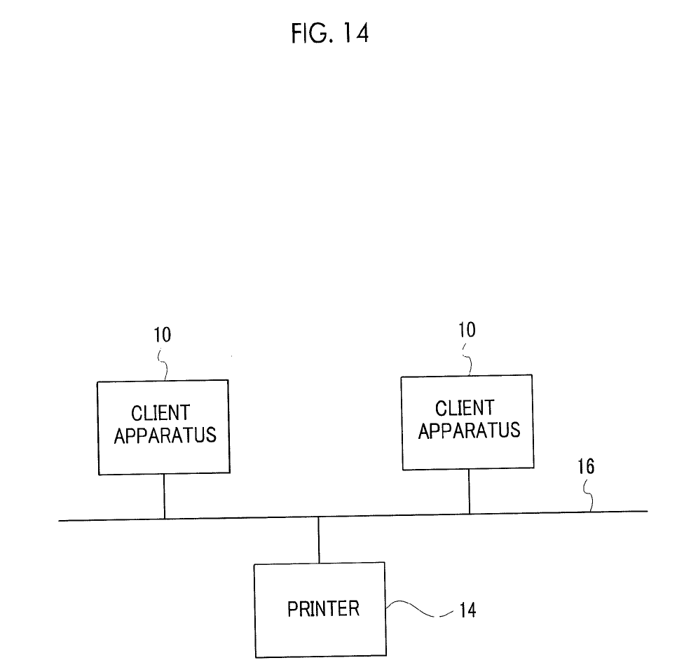

In addition, although an example in which the server apparatus 12 stores and manages printing information and transmits the printing information to the printer 14 in response to a request from the printer 14 is described in the above exemplary embodiment, the invention is not limited to this. For example, as shown in FIG. 14, the server apparatus 12 may not be provided, and the function of the server apparatus 12 may be set by connecting the printer 14 to the communication unit 16 so that the printer 14 may communicate with each client apparatus 10. In this case, the CPU 30 of the printer 14 may execute a program may be stored in the ROM 31, for example) of the processing routine in order to execute the above processing routine, and the printer 14 may receive the printing information directly from the client apparatus 10 and store and manage it. In this case, since the printer 14 manages the printing information, transmission and reception of the printing information are not necessary.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A printing information managing device comprising:
a storage processing unit that when printing information transmitted from a transmission device is received, stores the received printing information in a memory and deletes printed printing information from the memory;
a batch print permission date and time setting unit that sets batch print permission date and time, which is end date and time of a period of batch printing when batch printing of the printing information stored in the memory is designated, for each item of the received printing information; and
a controller that when the batch printing is designated, makes a control such that printing information not past the batch print permission date and time of the printing information stored in the memory is printed by a printer and printing information past the batch print permission date and time is not printed by the printer.

2. The printing information managing device according to claim 1,
wherein when selective printing for printing printing information selected from the printing information stored in the memory is designated, the controller makes a control such that printing information not past the batch print permission date and time of the printing information stored in the memory is selected and printed by the printer and printing information past the batch print permission date and time is not selected so as not to be printed by the printer when all select, which is to collectively select printing information to be printed, is designated.

3. The printing information managing device according to claim 1, further comprising:
a storage permission date and time setting unit that sets storage permission date and time, which is date and time later than the batch print permission date and time and is also end date and time of a period for which storage of printing information in the memory is allowed, for each item of the received printing information;
a return unit that returns printing information past the storage permission date and time, of the printing information stored in the memory, to a transmitting person of the printing information; and
a deletion unit that deletes the printing information returned by the return unit from the memory.

4. The printing information managing device according to claim 2, further comprising:
a storage permission date and time setting unit that sets storage permission date and time, which is date and time later than the batch print permission date and time and is also end date and time of a period for which storage of printing information in the memory is allowed, for each item of the received printing information;
a return unit that returns printing information past the storage permission date and time, of the printing information stored in the memory, to a transmitting person of the printing information; and
a deletion unit that deletes the printing information returned by the return unit from the memory.

5. The printing information managing device according to claim 3,
wherein a length of the period for which storage of printing information in the memory is allowed is set in advance by a transmitting person who transmits the printing information from the transmission device.

6. The printing information managing device according to claim 4,
wherein a length of the period for which storage of printing information in the memory is allowed is set in advance by a transmitting person who transmits the printing information from the transmission device.

7. The printing information managing device according to claim 1,
wherein a length of the period of hatch printing is set in advance by a transmitting person who transmits the printing information from the transmission device.

8. The printing information managing device according to claim 2,
wherein a length of the period of batch printing is set in advance by a transmitting person who transmits the printing information from the transmission device.

9. The printing information managing device according to claim 3,
wherein a length of the period of batch printing is set in advance by a transmitting person who transmits the printing information from the transmission device.

10. The printing information managing device according to claim 4,
wherein a length of the period of batch printing is set in advance by a transmitting person who transmits the printing information from the transmission device.

11. The printing information managing device according to claim 5,
wherein a length of the period of batch printing is set in advance by a transmitting person who transmits the printing information from the transmission device.

12. The printing information managing device according to claim 6,
wherein a length of the period of batch printing is set in advance by a transmitting person who transmits the printing information from the transmission device.

13. A printer comprising:
a printing unit that performs printing on the basis of printing information; and
the printing information managing device according claim 1.

14. A printing information managing system comprising:
a transmission device that transmits at least printing information; and
the printing information managing device according to claim 1.

15. A printing system comprising:
a transmission device that transmits at least printing information; and
the printer according to claim 13.

16. A non-transitory computer readable medium that stores a printing information managing program causing a computer to function as:
a storage processing unit that when printing information transmitted from a transmission device is received, stores the received printing information in a memory and deletes printed printing information from the memory;
a batch print permission date and tine setting unit that sets batch print permission dace and time, which is end date and time of a period of hatch printing when batch printing of the printing information stored in the memory is designated, for each item of the received printing information; and
a controller that when the batch printing is designated, makes a control such that printing information not past the batch print permission date and time of the printing information stored in the memory is printed by a printer and printing information past the batch print permission date and time is not printed by the printer.

17. A non-transitory computer readable medium that stores a program causing a computer to perform a process for printing information managing, the process comprising:
when printing information transmitted from a transmission device is received, storing the received printing information in a memory arid deleting printed printing information from the memory;
setting batch print permission date and time, which is end date and time of a period of batch printing when batch printing of the printing information stored in the memory is designated, for each item of the received printing information; and
when the batch printing is designated, making a control such that printing information not past the batch print permission date and time of the printing information stored in the memory is printed by a printer and printing information past the batch print permission date and time is not printed by the printer.
